(19) United States
(12) Patent Application Publication
(10) Pub. No.: US 2026/0155411 A1
(43) Pub. Date: Jun. 4, 2026

(54) FUEL CELL SYSTEM

(71) Applicant: Honda Motor Co., Ltd., Tokyo (JP)

(72) Inventors: Yuuki Sakamoto, Saitama (JP); Koichi Kimura, Saitama (JP); Shuto Maniwa, Saitama (JP); Hikaru Watanabe, Saitama (JP)

(21) Appl. No.: 19/401,105

(22) Filed: Nov. 25, 2025

(30) Foreign Application Priority Data
Dec. 2, 2024 (JP) 2024-209277

(51) Int. Cl. H01M 8/04746; H01M 8/04119; H01M 8/0432; H01M 8/0438; H01M 8/04664

(52) U.S. Cl. CPC H01M 8/04753; H01M 8/04149; H01M 8/04358; H01M 8/04395; H01M 8/0441; H01M 8/04686

(57) ABSTRACT

A fuel cell system including a gas supply part supplying cathode gas to a fuel cell stack through a supply flow path, a humidifier connected to the supply flow path and a discharge flow path of the fuel cell stack and humidifying cathode gas with a moisture included in cathode exhaust gas, and an electronic control unit including a microprocessor. The microprocessor is configured to perform acquiring information on a first pressure of the cathode gas flowing through a first flow path inside the humidifier, acquiring information on a second pressure of the cathode exhaust gas flowing through a second flow path inside the humidifier, and calculating a leakage amount of the cathode gas from the first flow path to the second flow path inside the humidifier, based on a difference between the first pressure and the second pressure.

### CROSS-REFERENCE TO RELATED APPLICATION

This application is based upon and claims the benefit of priority from Japanese Patent Application No. 2024-209277 filed on Dec. 2, 2024, the content of which is incorporated herein by reference.

### BACKGROUND OF THE INVENTION

### Field of the Invention

This invention relates to a fuel cell system including a humidifier.

### Description of the Related Art

In recent years, technological developments have been made on a fuel cell that contribute to energy efficiency in order to ensure access to energy that is affordable, reliable, sustainable and advanced by more people. This type of fuel cell is generally provided with a humidifier that humidifies a cathode gas supplied to a fuel cell stack. As a technology relating to such fuel cells, there is known a technique in which an internal leak in the humidifier is detected.

For example, in the fuel cell system described in U.S. Patent Application Publication No. 2008/0014478 (US 2008/0014478 A), an oxygen concentration of the cathode exhaust gas discharged from the fuel cell stack is detected by an oxygen sensor, and the cathode stoichiometry is determined based on the detection value of the oxygen sensor. Then, by comparing this cathode stoichiometry with the amount of oxygen supplied to the fuel cell system, an internal leak of cathode gas from the dry side to the wet side of the humidifier is detected.

However, the fuel cell system described in US 2008/0014478 A requires an oxygen sensor to detect the internal leak, which leads to an increase in cost.

### SUMMARY OF THE INVENTION

An aspect of the present invention is a fuel cell system including a fuel cell stack to which a cathode gas including oxygen is supplied through a supply flow path and from which a cathode exhaust gas is discharged through a discharge flow path, a gas supply part configured to supply the cathode gas to the fuel cell stack through the supply flow path, a humidifier connected to the supply flow path and the discharge flow path, and configured to humidify the cathode gas with a moisture included in the cathode exhaust gas, and an electronic control unit including a microprocessor and a memory connected to the microprocessor. The microprocessor is configured to perform acquiring information on a first pressure of the cathode gas flowing through a first flow path inside the humidifier, acquiring information on a second pressure of the cathode exhaust gas flowing through a second flow path inside the humidifier, and calculating a leakage amount of the cathode gas from the first flow path to the second flow path inside the humidifier, based on a difference between the first pressure and the second pressure.

### BRIEF DESCRIPTION OF THE DRAWINGS

The objects, features, and advantages of the present invention will become clearer from the following description of embodiments in relation to the attached drawings, in which:

FIG. 1 is a diagram illustrating a schematic configuration of a fuel cell system according to an embodiment of the present invention;

FIG. 2 is a view schematically illustrating an overall configuration of a fuel cell stack included in the fuel cell system of FIG. 1;

FIG. 3 is a diagram schematically illustrating a configuration of a humidifier included in the fuel cell system of FIG. 1:

FIG. 4 is a diagram illustrating a principle of occurrence of an internal leakage in the humidifier of FIG. 3;

FIG. 5 is a diagram illustrating a result of a durability test of the humidifier of FIG. 3;

FIG. 6 is a block diagram illustrating a control configuration of a leak detection device according to the embodiment of the present invention;

FIG. 7 is a diagram schematically illustrating a flow path for which pressure loss is calculated by the pressure calculation unit of FIG. 6; and

FIG. 8 is a flowchart illustrating an example of processing performed by a controller of FIG. 6.

### DETAILED DESCRIPTION OF THE INVENTION

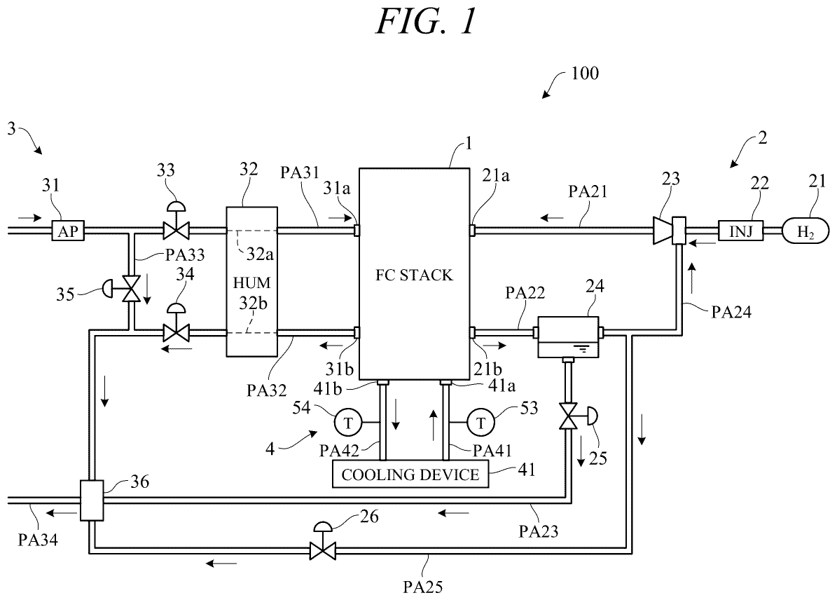

Hereinafter, an embodiment of the present invention will be described with reference to FIGS. 1 to 8. FIG. 1 is a diagram illustrating a schematic configuration of a fuel cell system 100 according to an embodiment of the present invention. The fuel cell system 100 of FIG. 1 is mounted on, for example, a vehicle (fuel cell vehicle) and generates electric power to be supplied to a traveling motor of the vehicle.

As illustrated in FIG. 1, the fuel cell system 100 includes a fuel cell stack 1, a fuel gas supply and exhaust part 2 that supplies a fuel gas (anode gas) to the fuel cell stack 1 and discharges the fuel gas from the fuel cell stack 1, an oxidant gas supply and exhaust part 3 that supplies an oxidant gas (cathode gas) to the fuel cell stack 1 and discharges the oxidant gas from the fuel cell stack 1, and a cooling medium supply and exhaust part 4 that supplies a cooling medium to the fuel cell stack 1 and discharges the cooling medium from the fuel cell stack 1. The fuel gas is, for example, hydrogen. The oxidant gas is, for example, air containing oxygen. The cooling medium is, for example, water or a coolant liquid containing ethylene glycol or propylene glycol.

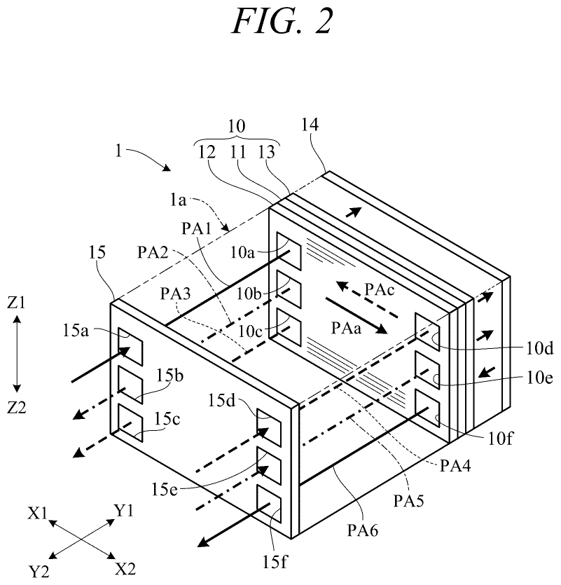

FIG. 2 is a perspective view schematically illustrating an overall configuration of the fuel cell stack 1. Hereinafter, for the sake of convenience, three-axis directions orthogonal to each other as illustrated in the drawing are defined as an X1-X2 direction, a Y1-Y2 direction, and a Z1-Z2 direction. As illustrated in FIG .2, the fuel cell stack 1 includes a stacked body 1a configured by stacking a plurality of power generation cells 10 in the Y1-Y2 direction. In FIG. 1, the configuration of a single power generation cell 10 is illustrated.

The power generation cell includes a membrane electrode assembly 11 having a substantially rectangular plate shape extending in the X1-X2 direction and the Z1-Z2 direction, and a pair of separators each having a substantially rectangular plate shape, that is, an anode separator 12 and a cathode separator 13, which are disposed on both sides of the membrane electrode assembly 11 in the Y1-Y2 direction. At the ends of the power generation cell 10 (membrane electrode assembly 11, anode separator 12 and cathode separator 13) in the X1-X2 direction, through-holes 10a to 10f penetrating the power generation cell 10 in the Y1-Y2 direction are opened. More specifically, at the end of the power generation cell 10 on the X 1 direction side, the through-holes 10a to 10c are arranged along the Z1-Z2 direction, and at the end on the X2 direction side, the through-holes 10d to 10f are arranged along the Z1-Z2 direction. The through-holes 10a to 10c are through-holes for fuel gas supply, cooling medium discharge, and oxidant gas discharge, respectively. The through-holes 10d to 10f are through-holes for oxidant gas supply, cooling medium supply, and fuel gas discharge, respectively.

On both sides of the stacked body 1a in the Y1-Y2 direction, end units 14 and 15, each having a substantially rectangular plate shape, are arranged. The end unit 15 is provided with through-holes 15a to 15f penetrating the end unit 15 in the Y1-Y2 direction so as to communicate with the through-holes 10a to 10f. More specifically, at the end of the end unit 15 on the X1 direction side, a through-hole 15a for fuel gas supply, a through-hole 15b for cooling medium discharge, and a through-hole 15c for oxidant gas discharge are arranged along the Z1-Z2 direction. At the end of the end unit 15 on the X2 direction side, a through-hole 15d for oxidant gas supply, a through-hole 15e for cooling medium supply, and a through-hole 15f for fuel gas discharge are arranged along the Z1-Z2 direction.

In each power generation cell 10 of the fuel cell stack 1, the fuel gas is supplied through the through-holes 15a and 10a as illustrated by the arrow PA1 (solid line), the oxidant gas is supplied through the through-holes 15d and 10d as illustrated by the arrow PA4 (dotted line), and the cooling medium is supplied through the through-holes 15e and 10e as illustrated by the arrow PA5 (chain line). From the fuel cell stack 1, the fuel gas is discharged through the through-holes 10f and 15f as illustrated by the arrow PA6 (solid line), the oxidant gas is discharged through the through-holes 10c and 15c as illustrated by the arrow PA3 (dotted line), and the cooling medium is discharged through the through-holes 10b and 15b as illustrated by the arrow PA2 (chain line).

Although not illustrated, the membrane electrode assembly 11 includes an electrolyte membrane and a pair of electrodes formed on both sides of the electrolyte membrane in the Y1-Y2 direction. The electrolyte membrane is, for example, a solid polymer electrolyte membrane. The electrode on the Y2 direction side is an anode electrode disposed opposite the anode separator 12, and an anode flow path PAa (solid line) is formed between the anode electrode and the anode separator 12 so as to communicate with the through-holes 10a and 10f. As a result, as illustrated by the solid line arrow, the fuel gas flows along the anode flow path PAa from the X1 direction to the X2 direction.

The electrode on the Y1 direction side is a cathode electrode disposed opposite the cathode separator 13, and a cathode flow path PAc (dotted line) is formed between the cathode electrode and the cathode separator 13 so as to communicate with the through-holes 10d and 10c. As a result, as illustrated by the dotted line arrow, the oxidant gas flows along the cathode flow path PAc from the X2 direction to the X1 direction. The anode separator 12 and the cathode separator 13 of adjacent power generation cells 10 are arranged adjacent to each other in the Y1-Y2 direction, and a cooling medium flow path is formed between the anode separator 12 and the cathode separator 13 so as to communicate with the through-holes 10e and 10b. As a result, the cooling medium flows along the cooling medium flow path from the X2 direction to the X1 direction.

In the anode electrode of the membrane electrode assembly 11, the fuel gas (hydrogen) supplied through the anode flow path PAa is ionized by the action of a catalyst and moves to the cathode electrode side through the electrolyte membrane. The electrons generated at this time pass through an external circuit and are extracted as electrical energy. In the cathode electrode of the membrane electrode assembly 11, the oxidant gas (oxygen) supplied through the cathode flow path PAc reacts with the hydrogen ions led from the anode electrode and the electrons moved from the anode electrode, generating water. The generated water provides appropriate humidity to the electrolyte membrane, and excess water is discharged to the outside.

As illustrated in FIG. 1, the fuel gas supply and exhaust part 2 includes a fuel gas tank 21 in which fuel gas (anode gas) is stored, a fuel gas supply flow path PA21 for guiding the fuel gas in the fuel gas tank to the fuel gas inlet 21a of the fuel cell stack 1, and a fuel gas discharge flow path PA22 through which the fuel gas (fuel exhaust gas) discharged from the fuel gas outlet 21b of the fuel cell stack 1 flows. The fuel gas inlet 21a communicates with the through-hole 15a of the end unit 15 (FIG. 2), and the fuel gas outlet 21b communicates with the through-hole 15f. An injector 22 and an ejector 23 are arranged in the fuel gas supply flow path PA21. A gas-liquid separator 24 is connected to the fuel gas discharge flow path PA22.

The injector 22 is configured by a single electromagnetic injector or multiple electromagnetic injectors connected in parallel. The fuel gas is injected by the operation of the injector 22, and the injected fuel gas flows toward the ejector 23. The ejector 23 includes a nozzle section, a suction section, a merging section, and a diffuser section. The fuel gas injected from the injector 22 passes through the small-diameter nozzle section and then flows into the diffuser section via the merging section. The fuel gas that has passed through the ejector 23 is supplied to the fuel cell stack 1 via the fuel gas inlet 21a.

The fuel gas discharged from the fuel gas outlet 21b, that is, the fuel exhaust gas (anode off-gas), is separated into fuel gas and water by the gas-liquid separator 24. The water separated by the gas-liquid separator 24 is discharged to the outside via an electromagnetic drain valve 25 and a drain flow path PA23. The fuel gas separated by the gas-liquid separator 24 is guided to the circulation flow path PA24. The gas-liquid separator 24 is connected to the ejector 23 via the circulation flow path PA24. The fuel gas flowing through the circulation flow path PA24 can be discharged to the outside via a drain flow path PA25 and an electromagnetic drain valve 26.

In the ejector 23, the fuel gas separated by the gas-liquid separator 24 is sucked in via the circulation flow path PA24 by the flow of fuel gas injected from the injector 22. The sucked-in fuel gas merges with the fuel gas that has passed through the nozzle section of the ejector 23 at the merging section of the ejector 23, and after being made into a uniform flow in the diffuser section of the ejector 23, it is supplied to the fuel cell stack 1 via the fuel gas inlet 21a.

The oxidant gas supply and exhaust part 3 includes an electric air pump 31 that generates high-pressure oxidant gas (cathode gas), an oxidant gas supply flow path PA31 that guides the oxidant gas generated by the air pump 31 to the oxidant gas inlet 31a of the fuel cell stack 1, and an oxidant gas discharge flow path PA32 through which the oxidant gas (oxidant exhaust gas) discharged from the oxidant gas outlet 31b of the fuel cell stack 1 flows. The oxidant gas inlet 31 a communicates with the through-hole 15d of the end unit 15 (FIG. 2), and the oxidant gas outlet 31 b communicates with the through-hole 15c. The air pump 31 functions as a gas supply part that compresses air taken from the atmosphere to generate high-pressure oxidant gas. The air pump 31 may be configured as a compressor. A humidifier 32 is arranged intersecting the oxidant gas supply flow path PA31 and the oxidant gas discharge flow path PA32.

The humidifier 32 has a dry flow path 32a communicating with the oxidant gas supply flow path PA31 and a wet flow path 32b communicating with the oxidant gas discharge flow path PA32. The oxidant exhaust gas (anode off-gas) contains moisture generated by the fuel cell stack 1. Therefore, the humidity of the oxidant exhaust gas flowing through the wet flow path 32b is higher than that of the oxidant gas flowing through the dry flow path 32a. In the humidifier 32, a humidity exchange occurs between the oxidant gas and the oxidant exhaust gas, and the oxidant gas in the dry flow path 32a is humidified by the moisture (water vapor) contained in the oxidant exhaust gas in the wet flow path 32b.

The oxidant gas supply and exhaust part 3 further includes a bypass flow path PA33. The bypass flow path PA33 is connected to the oxidant gas supply flow path PA31 upstream of the humidifier 32 and the oxidant gas discharge flow path PA32 downstream of the humidifier 32. Through the bypass flow path PA33, the oxidant gas can flow bypassing the humidifier 32 and the fuel cell stack 1.

In the oxidant gas supply flow path PA31, an electromagnetic control valve 33 with adjustable opening is provided between the bypass flow path PA33 and the humidifier 32. In the oxidant gas discharge flow path PA32, an electromagnetic control valve 34 with adjustable opening is provided between the bypass flow path PA33 and the humidifier 32. In the bypass flow path PA33, an electromagnetic control valve 35 with adjustable opening is provided. By controlling the air pump 31 and the control valves 33 to 35, the supply amount and pressure of the oxidant gas supplied to the fuel cell stack 1 can be adjusted. Additionally, by controlling the control valves 33 to 35, the bypass amount of the oxidant gas bypassing the fuel cell stack 1 can be adjusted.

No pressure sensor is provided in the oxidant gas supply flow path PA31, and the pressure of the oxidant gas supplied to the fuel cell stack 1 is determined by calculation as described later. Similarly, no pressure sensor is provided in the oxidant gas discharge flow path PA32, and the pressure of the oxidant exhaust gas discharged from the fuel cell stack 1 is determined by calculation as described later.

A diluter 36 is connected to the downstream end of the oxidant gas discharge flow path PA32. The ends of the drain flow paths PA23 and PA25 are also connected to the diluter 36. In the diluter 36, the fuel exhaust gas guided through the drain flow path PA25 is diluted with the oxidant exhaust gas and discharged to the outside (atmosphere) through the drain flow path PA34 along with the liquid water guided through the drain flow path PA23.

The cooling medium supply and exhaust part 4 includes a cooling device 41, a cooling medium supply flow path PA41 connecting the cooling device 41 and the cooling medium inlet 41a of the fuel cell stack 1, and a cooling medium discharge flow path PA42 connecting the cooling device 41 and the cooling medium outlet 41b of the fuel cell stack 1. The cooling medium inlet 41 a communicates with the through-hole 15e of the end unit 15 (FIG. 2), and the cooling medium outlet 41 b communicates with the through-hole 15b. A temperature sensor 53 for detecting the temperature of the cooling medium (cooling medium inlet temperature) is provided in the cooling medium supply flow path PA41. A temperature sensor 54 for detecting the temperature of the cooling medium is provided in the cooling medium discharge flow path PA42. Although not shown, the cooling device 41 includes a pump for pressurizing the cooling medium toward the fuel cell stack 1, a heat exchanger (radiator) for cooling the cooling medium that has been heated by passing through the fuel cell stack 1, and a cooling fan for blowing cooling air to the heat exchanger.

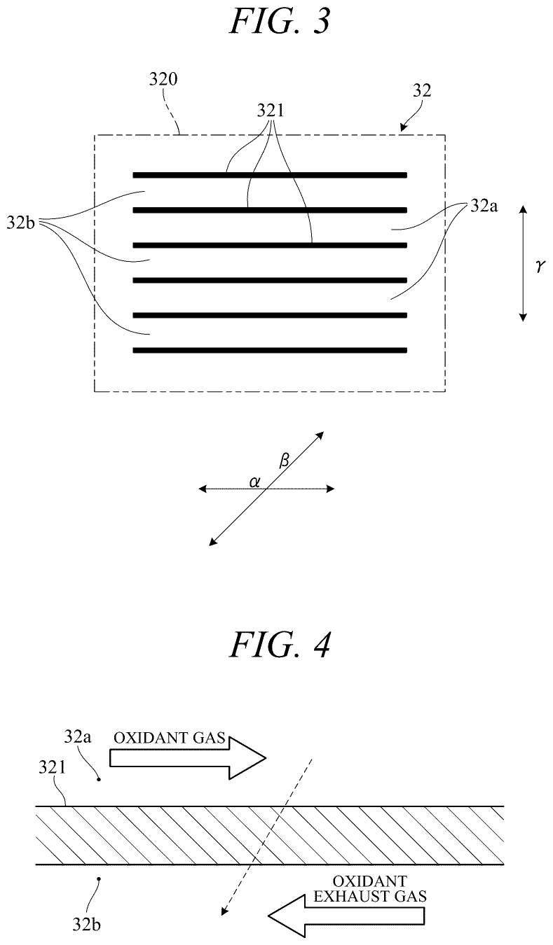

FIG. 3 is a diagram schematically illustrating a configuration of the humidifier 32. In FIG. 3, three axial directions orthogonal to each other are respectively denoted by an α direction, a β direction, and a γ direction. In a state where the humidifier 32 is mounted on the vehicle, the α direction or the β direction coincides with the gravity direction, for example. As illustrated in FIG. 3, the humidifier 32 includes a case 320 having a substantially rectangular parallelepiped shape and a plurality of water-permeable membranes 321 stacked in the case 320. The water-permeable membranes 321 extend in the α direction and the β direction, have a substantially rectangular plate shape, and are stacked in the γ direction.

More specifically, inside the humidifier, the dry flow path 32a (FIG. 1) through which the oxidant gas flows and the wet flow path 32b (FIG. 1) through which the oxidant exhaust gas flows are alternately formed via the water-permeable membranes 321. The flow direction of the oxidant gas is, for example, the α direction, and the flow direction of the oxidant exhaust gas is, for example, the β direction. Both the flow direction of the oxidant gas and the flow direction of the oxidant exhaust gas may be the α direction or the β direction. For example, the oxidant gas may flow toward one side in the α direction, and the oxidant exhaust gas may flow toward the other side in the α direction.

When the flow direction of the oxidant gas is the α direction, the oxidant gas supply flow path PA31 (FIG. 1) is connected to one end and the other end of the case 320 in the α direction, and the oxidant gas supply flow path PA31 communicates with the dry flow path 32a. When the flow direction of the oxidant exhaust gas is the β direction, the oxidant gas discharge flow path PA32 (FIG. 1) is connected to one end and the other end of the case 320 in the β direction, and the oxidant gas discharge flow path PA32 communicates with the wet flow path 32b.

As described above, inside the humidifier 32, the wet flow path 32b and the dry flow path 32a are alternately formed via the water-permeable membranes 321. The water-permeable membranes 321 are, for example, hollow fiber membranes consisting of polymer-resin hollow fibers. In such water-permeable membranes 321, the hollow fiber membrane's capillary action separates the moisture contained in the oxidant exhaust gas, the separated moisture permeates the hollow fiber membrane and moves from the wet flow path 32b to the dry flow path 32a, and the oxidant gas is humidified. Therefore, the water-permeable membranes 321 can permeate only moisture (water vapor) contained in the oxidant exhaust gas.

During the operation of the fuel cell system 100, the pressure of the oxidant gas flowing through the dry flow path 32a is higher than the pressure of the oxidant exhaust gas flowing through the wet flow path 32b, and a differential pressure is generated between flow paths 32a and 32b. The differential pressure increases as the supply rate of the oxidant gas increases. Therefore, in the humidifier 32, as illustrated in FIG. 4, an internal leakage may occur due to the differential pressure.

That is, as indicated by a dashed-line arrow in FIG. 4, the oxidant gas may leak from the dry flow path 32a to the wet flow path 32b via the water-permeable membranes 321. Alternatively, the water-permeable membranes 321 may be greatly damaged, such as tearing of the water-permeable membranes 321, and the leakage amount may significantly increase.

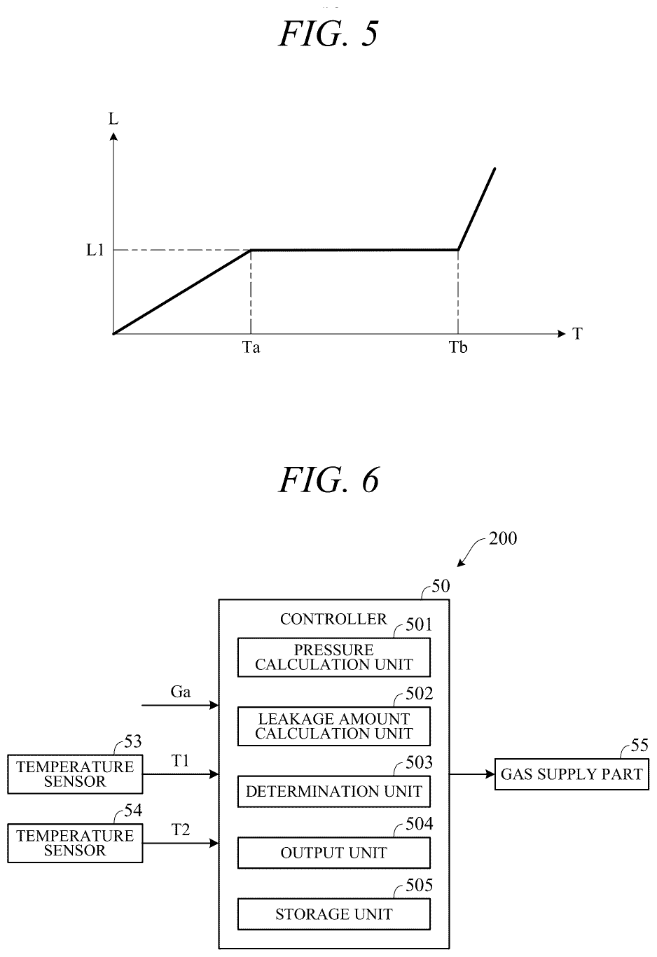

FIG. 5 is a diagram illustrating a result of a durability test of the humidifier 32 in a case where a predetermined differential pressure is applied between the flow paths 32a and 32b. In FIG. 5, the horizontal axis represents a time T (the count of differential pressure generations), and the vertical axis represents an internal leakage amount L. As illustrated in FIG. 5, the internal leakage amount L gradually increases with the lapse of time, and becomes substantially constant (L1) when reaching a predetermined time Ta. Thereafter, the internal leakage amount L is constant (=L1) until reaching a predetermined time Tb, and when exceeding the predetermined time Tb, the internal leakage amount L rapidly increases. That is, the increase rate of the internal leakage amount L after the predetermined time Tb is larger than the increase rate before the predetermined time Ta. The reason why the internal leakage amount L rapidly increases is, for example, that holes are formed in the water-permeable membranes 321. Based on the test result of FIG. 5, the durability life of the humidifier 32 can be determined to be, for example, a predetermined time Tb.

When the internal leakage occurs in the humidifier 32, the supply of the oxidant gas to the fuel cell stack 1 becomes insufficient, and power generation becomes unstable. Therefore, it is preferable to detect the internal leakage amount of the humidifier 32 and increase the supply rate of the oxidant gas flowing through the humidifier 32 by an amount corresponding to the internal leakage amount, which can suppress the power generation from becoming unstable. In the present embodiment, the internal leakage amount is detected using a leak detection device. The leak detection device is included in the fuel cell system 100, and is configured to detect the internal leakage amount with an inexpensive configuration. Hereinafter, the configuration of the leak detection device will be described.

FIG. 6 is a block diagram illustrating a control configuration of a leak detection device 200. As illustrated in FIG. 6, the leak detection device 200 includes a controller 50, temperature sensors 53 and 54 communicably connected to the controller 50, and a gas supply part 55. The gas supply part 55 is the collective term for elements, such as the air pump 31 and the control valves 33 to 35, that supply the oxidant gas to the fuel cell stack 1 via the oxidant gas supply flow path PA31.

The controller 50 reads signals indicating the temperatures T1 and T2 respectively detected by the temperature sensors 53 and 54. The controller 50 communicates with another controller (for example, a power generation controller), and reads the power generation amount required by the vehicle (required power generation amount), which is output by the another controller, that is, the target flow rate of the oxidant gas corresponding to the total required power generation amount required for the fuel cell system 100 (oxidant gas target value Ga).

More specifically, the power generation controller calculates target drive torque of the travel motor, based on a signal from an accelerator opening sensor that detects an opening degree of an accelerator pedal, and calculates the required power generation amount necessary for the travel motor to generate the target drive torque. Alternatively, the power generation controller calculates the required power generation amount, based on a signal from a battery sensor that detects a remaining capacity SOC (State of Charge) of the battery, so that the remaining capacity of the battery has a predetermined value. The oxidant gas target value Ga corresponding to the required power generation amount is calculated and is output to the controller 50.

The controller 50 is a computer including an arithmetic processing device including a CPU, a ROM, a RAM, and other peripheral circuits. The controller 50 includes a pressure calculation unit 501, a leakage amount calculation unit 502, a determination unit 503, an output unit 504, and a storage unit 505 as functional components. The shape (area, length, and the like) of each flow path through which the oxidant gas flows, the pressure loss coefficient, and the like are stored in advance in the storage unit 505.

As illustrated in FIG. 2, a through-hole (inlet portion) 15d for supplying oxidant gas of the fuel cell stack 1 is provided in the vicinity of a through-hole (inlet portion) 15e for supplying a cooling medium. More specifically, the through-hole 15d and the through-hole 15e are disposed adjacent to each other. Therefore, the temperature of the oxidant gas at the inlet of the fuel cell stack 1 (stack inlet) (gas inlet temperature T11) has a predetermined correlation with the temperature T1 at the stack inlet of the cooling medium detected by the temperature sensor 53, and the gas inlet temperature T11 increases as the temperature T1 increases. A through-hole (outlet portion) 15c for discharging oxidant gas of the fuel cell stack 1 is provided in the vicinity of a through-hole (outlet portion) 15b for discharging a cooling medium. More specifically, the through-hole 15c and the through-hole 15b are disposed adjacent to each other. Therefore, the temperature of the oxidant gas at the outlet of the fuel cell stack 1 (stack outlet) (gas outlet temperature T12) has a predetermined correlation with the temperature T2 at the stack outlet detected by the temperature sensor 54, and the gas outlet temperature T12 increases as the temperature T2 increases. These correlations are also stored in the storage unit 505 in advance.

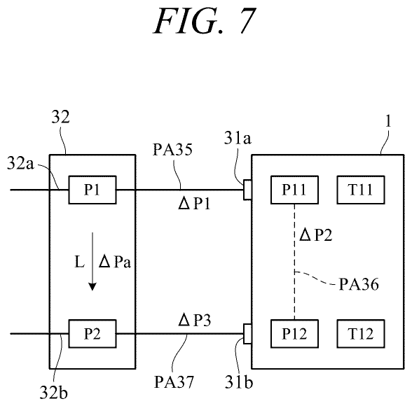

The pressure calculation unit 501 calculates pressure loss of a flow path from the dry flow path 32a to the wet flow path 32b of the humidifier 32 via the fuel cell stack 1. FIG. 7 is a diagram schematically illustrating a flow path in which pressure loss is calculated. As illustrated in FIG. 7, the flow path from the dry flow path 32a to the wet flow path 32b of the humidifier 32 can be divided into a stack upstream flow path PA35 from the dry flow path 32a to the fuel cell stack 1, an in-stack flow path PA36 from an oxidant gas inlet 31a to an oxidant gas outlet 31b of the fuel cell stack 1, and a stack downstream flow path PA37 from the fuel cell stack 1 to the humidifier 32.

In these flow paths PA35 to PA37, the pressure loss ΔP1 of the stack upstream flow path PA35 is minute (substantially zero), and this pressure loss ΔP1 can be neglected. Therefore, the pressure (inlet pressure) P11 at the inlet of the oxidant gas in the fuel cell stack 1 is substantially equal to the pressure P1 (dry-side pressure) of the dry flow path 32a of the humidifier 32, and the pressure calculation unit 501 regards the inlet pressure P11 as the pressure P1.

The pressure calculation unit 501 calculates the inlet pressure P11 based on the oxidant gas target value Ga and the temperature T1 detected by the temperature sensor 53. Specifically, the pressure calculation unit 501 first calculates the gas inlet temperature T11 based on the temperature T1 of the stack inlet of the cooling medium detected by the temperature sensor 53 using a predetermined correlation stored in advance in the storage unit 505. Next, the pressure calculation unit 501 calculates the inlet pressure P11 (pressure P1) based on the calculated gas inlet temperature T11 and the oxidant gas target value Ga.

The pressure calculation unit 501 further calculates a pressure loss ΔP2 in the in-stack flow path PA36 and a pressure loss ΔP3 in the stack downstream flow path PA37. Specifically, the pressure calculation unit 501 first calculates the gas inlet temperature T11 based on the temperature T1 of the stack inlet of the cooling medium detected by the temperature sensor 53 using a predetermined correlation stored in advance in the storage unit 505. Next, the pressure calculation unit 501 calculates the volume flow rate of the oxidant gas at the stack inlet based on the calculated gas inlet temperature T11 and the inlet pressure P11 (pressure P1), and calculates the pressure loss ΔP2 of the oxidant gas in the in-stack flow path PA36 based on this volume flow rate and the pressure loss coefficient ζ1 of the in-stack flow path PA36 stored in advance in the storage unit 505.

Next, the pressure calculation unit 501 calculates the gas outlet temperature T12 based on the temperature T2 of the stack outlet of the cooling medium detected by the temperature sensor 54 using a predetermined correlation stored in advance in the storage unit 505. The pressure calculation unit 501 subtracts the pressure loss ΔP2 from the inlet pressure P11 to calculate the pressure (outlet pressure) P12 at the outlet of the oxidant gas in the fuel cell stack 1. The pressure calculation unit 501 calculates the volume flow rate of the oxidant gas at the stack outlet based on the calculated gas outlet temperature T12 and the outlet pressure P12, and calculates the pressure loss ΔP3 of the oxidant gas in the stack downstream flow path PA37 based on this volume flow rate and the pressure loss coefficient ζ2 of the stack downstream flow path PA37 stored in advance in the storage unit 505.

Next, the pressure calculation unit 501 calculates the pressure P2 (wet-side pressure) of the wet flow path 32b. Specifically, the wet-side pressure P2 is calculated by subtracting the pressure loss ΔP2 of the in-stack flow path PA36 and the pressure loss ΔP3 of the stack downstream flow path PA37 from the dry-side pressure P1. The pressure calculation unit 501 subtracts the wet-side pressure P2 from the dry-side pressure P1 to calculate the differential pressure ΔPa in the humidifier 32.

In the above description, the pressure loss ΔP1 of the stack upstream flow path PA35 has been neglected, but when the pressure loss ΔP1 cannot be neglected, the pressure calculation unit 501 may calculate the pressure loss ΔP1 using the temperature (for example, the temperature detected by the temperature sensor) and the pressure P1 of the oxidant gas at the outlet of the dry flow path 32a, and the pressure loss coefficient of the stack upstream flow path PA35. The pressure calculation unit 501 is only required to subtract the pressure loss ΔP1, the pressure loss ΔP2, and the pressure loss ΔP3 from the dry-side pressure P1 to calculate the wet-side pressure P2. The dry-side pressure P1 may be detected by a pressure sensor instead of being obtained by calculation. For example, a pressure sensor that detects the dry-side pressure P1 may be provided between the humidifier 32 and the control valve 33.

The internal leakage amount L of the humidifier 32 increases as the differential pressure ΔPa increases, and the internal leakage amount L and the differential pressure ΔPa have a predetermined correlation. This correlation is also stored in advance in the storage unit 505. The leakage amount calculation unit 502 calculates the internal leakage amount L of the humidifier 32 based on the differential pressure ΔPa calculated by the pressure calculation unit 501 and a predetermined correlation stored in the storage unit 505.

The determination unit 503 determines whether or not the internal leakage amount L calculated by the leakage amount calculation unit 502 is equal to or less than a predetermined value La stored in advance in the storage unit 505. The predetermined value La corresponds to an upper limit value of the internal leakage amount for which stable power generation can be continued. For example, a predetermined value L1 in FIG. 5 is set to the predetermined value La. When the internal leakage amount L exceeds the predetermined value La, the determination unit 503 determines that it is difficult to continue stable power generation.

The output unit 504 outputs a control signal to the gas supply part 55 (air pump 31 or the like) to supply the oxidant gas corresponding to the oxidant gas target value Ga. More specifically, the output unit 504 controls the gas supply part 55 to increase the supply rate of the oxidant gas by the internal leakage amount L calculated by the leakage amount calculation unit 502. This is referred to as a leakage compensation control. Thus, fuel gas and oxidant gas are supplied to the fuel cell stack 1 at a predetermined ratio, and stable power generation becomes possible.

When the determination unit 503 determines that the internal leakage amount L exceeds the predetermined value La, the output unit 504 controls the gas supply part 55 to stop the power generation. This is referred to as a stop control. In the stop control, the output unit 504 stops the driving of the air pump 31, or controls the control valves 33 to 35 to stop the supply rate of the oxidant gas to the fuel cell stack 1.

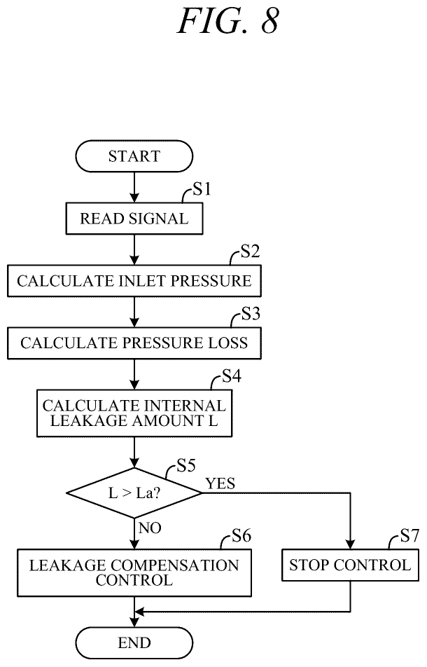

FIG. 8 is a flowchart illustrating an example of processing executed by the controller (CPU) 50. The processing shown in this flowchart is started, for example, when the power generation operation of the fuel cell system 100 is started. First, in S1 (S: processing step), the controller 50 reads a signal (oxidant gas target value Ga) from the power generation controller, and reads signals from the temperature sensors 53 and 54.

Next, in S2, the controller 50 calculates the inlet pressure P11 based on the oxidant gas target value Ga and the temperature T1 detected by the temperature sensor 53. The inlet pressure P11 is regarded as the pressure P1 (dry-side pressure) of the dry flow path 32a of the humidifier 32. Next, in S3, the controller 50 calculates the pressure loss ΔP2 of the in-stack flow path PA36 based on the calculated inlet pressure P1, the temperature T1 detected by the temperature sensor 53, and the pressure loss coefficient ζ1 of the in-stack flow path PA36. The controller 50 calculates the pressure loss ΔP3 of the stack downstream flow path PA37 based on the calculated pressure loss ΔP2, the temperature T2 detected by the temperature sensor 54, and the pressure loss coefficient ζ2 of the stack downstream flow path PA37.

Next, in S4, the controller 50 subtracts the pressure losses ΔP2 and ΔP3 calculated in S3 from the dry-side pressure P1 calculated in S2 to calculate the wet-side pressure P2. The controller 50 calculates the internal leakage amount L of the humidifier 32 based on the differential pressure ΔPa between the dry-side pressure P1 and the wet-side pressure P2.

Next, in S5, the controller 50 determines whether or not the internal leakage amount L calculated in S4 is larger than the predetermined value La. In a case where an affirmative determination is made in S5, the processing proceeds to S7, and in a case where a negative determination is made in S5, the processing proceeds to S6. In S6, a control signal is output to the gas supply part 55, and the leakage compensation control is executed to increase the supply rate of the oxidant gas by the internal leakage amount L. On the other hand, in S7, a control signal is output to the gas supply part 55, and the stop control is executed to stop the power generation.

The operation of the leak detection device 200 is summarized as follows. The dry-side pressure P1 of the oxidant gas in the dry flow path 32a of the humidifier 32 is calculated based on a signal indicating the oxidant gas target value Ga transmitted from another controller and a signal from the temperature sensor 53 (S2). The wet-side pressure P2 of the oxidant exhaust gas in the wet flow path 32b is calculated using the dry-side pressure P1 and signals from the temperature sensors 53 and 54. That is, the pressure loss ΔP2 of the in-stack flow path PA36 is calculated based on the dry-side pressure P1, the temperature T1 detected by the temperature sensor 53, and the pressure loss coefficient ζ1 of the in-stack flow path PA36, and the pressure loss ΔP3 of the stack downstream flow path PA37 is calculated based on the pressure loss ΔP2, the temperature T2 detected by the temperature sensor 54, and the pressure loss coefficient ζ2 of the stack downstream flow path PA37 (S3). The wet-side pressure P2 is calculated by subtracting the pressure losses ΔP2 and ΔP3 from the dry-side pressure P1.

Thus, it is not necessary to separately provide pressure sensors for detecting the dry-side pressure P1 and the wet-side pressure P2, and the configuration of the leak detection device 200 can be simplified. Since the pressure losses ΔP2 and ΔP3 are calculated based on the temperatures T1 and T2 of the cooling medium, it is not necessary to provide the sensors for detecting the temperature of the oxidant gas and the temperature of the oxidant exhaust gas, and the number of sensors can be reduced. When the wet-side pressure P2 is calculated, the internal leakage amount L is calculated based on the differential pressure ΔPa between the oxidant gas in the dry flow path 32a and the oxidant exhaust gas in the wet flow path 32b (S4). Thus, the internal leakage amount L can be obtained with an inexpensive configuration.

When the internal leakage amount L is calculated, the supply rate of the oxidant gas to the humidifier 32 is increased by an amount corresponding to the internal leakage amount L (S6). Thus, oxidant gas corresponding to the oxidant gas target value Ga is supplied to the fuel cell stack 1, and the stable power generation is achieved. On the other hand, when the internal leakage amount L exceeds the predetermined value La, the supply of the oxidant gas to the fuel cell stack 1 is stopped (S7). Thus, in a case where the humidifier 32 is damaged, the power generation in the fuel cell stack 1 can be stopped. Therefore, high safety is achieved.

According to the present embodiment, the following operations and effects are achievable.
(1) The fuel cell system 100 includes: the fuel cell stack 1 to which oxidant gas (cathode gas) containing oxygen is supplied via the oxidant gas supply flow path PA31 and from which oxidant exhaust gas (cathode off-gas) is exhausted via the oxidant gas discharge flow path PA32; the gas supply part 55 that supplies the oxidant gas to the fuel cell stack 1 via the oxidant gas supply flow path PA31; the humidifier 32 that is connected to the oxidant gas supply flow path PA31 and the oxidant gas discharge flow path PA32 and humidifies the oxidant gas with moisture contained in the oxidant exhaust gas; the pressure calculation unit 501 that calculates pressure (dry-side pressure P1) of the oxidant gas flowing through the dry flow path 32a inside the humidifier 32 and calculates pressure (wet-side pressure P2) of the oxidant exhaust gas flowing through the wet flow path 32b inside the humidifier 32; and the leakage amount calculation unit 502 that calculates a leakage amount (internal leakage amount L) of the oxidant gas from the dry flow path 32a to the wet flow path 32b inside the humidifier 32 based on a difference between the dry-side pressure P1 and the wet-side pressure P2, that is, the differential pressure ΔPa (FIGS. 1 and 6). Thus, an oxygen sensor or the like that detects the oxygen concentration of the oxidant exhaust gas is unnecessary, and the internal leakage amount L of the humidifier 32 can be detected with an inexpensive configuration.
(2) The fuel cell system 100 (leak detection device 200) further includes the output unit 504 that controls the gas supply part 55 based on the leakage amount of the oxidant gas calculated by the leakage amount calculation unit 502 (FIG. 6). Thus, the flow rate of the oxidant gas flowing into the humidifier 32 can be increased by an amount corresponding to the internal leakage amount L, and the stable power generation can be achieved in the fuel cell stack 1.
(3) The pressure calculation unit 501 obtains the pressure loss ΔP2 of the oxidant gas from the oxidant gas inlet 31a of the fuel cell stack 1 to which the oxidant gas supply flow path PA31 is connected to the oxidant gas outlet 31b of the fuel cell stack 1 to which the oxidant gas discharge flow path PA32 is connected, and the pressure loss ΔP3 of the oxidant exhaust gas from the oxidant gas outlet 31b to the humidifier 32, and calculates the wet-side pressure P2 based on the calculated dry-side pressure P1, the pressure loss ΔP2, and the pressure loss ΔP3 (FIG. 7). Thus, the pressure sensor or the like for detecting the wet-side pressure P2 is unnecessary, and the wet-side pressure P2 can be calculated with an inexpensive configuration.
(4) The fuel cell system 100 further includes the temperature sensor 53 that detects the temperature T1 of the cooling medium flowing into the fuel cell stack 1, and the temperature sensor 54 that detects the temperature T2 of the cooling medium flowing out of the fuel cell stack 1 (FIG. 1). The pressure calculation unit 501 calculates the pressure loss ΔP2 based on the temperature T1 of the cooling medium detected by the temperature sensor 53, and calculates the pressure loss ΔP3 based on the temperature T2 of the cooling medium detected by the temperature sensor 54. Thus, it is possible to calculate the pressure losses ΔP1 and ΔP2 with an inexpensive configuration without providing a temperature sensor that detects the temperature of the oxidant gas and the temperature of the oxidant exhaust gas.
(5) The output unit 504 controls the gas supply part 55 so that the flow rate of the oxidant gas supplied to the fuel cell stack 1 increases with an increase in the leakage amount (internal leakage amount L) of the oxidant gas calculated by the leakage amount calculation unit 502. When the leakage amount of the oxidant gas calculated by leakage amount calculation unit 502 exceeds a predetermined value La, the output unit 504 controls the power generation operation to stop the power generation in the fuel cell stack 1 (FIG. 8). Thus, the stable power generation can be continued in the fuel cell stack 1.
(6) The humidifier 32 is configured by stacking a plurality of water-permeable membranes 321, and the dry flow path 32a and the wet flow path 32b are alternately formed in the stacking direction of the water-permeable membranes 321 (FIG. 3). Thus, it is possible to effectively exchange humidity between the oxidant gas and the oxidant exhaust gas.

The above embodiment can be modified to various forms. Hereinafter, several modified examples will be described. In the above embodiment, oxidant gas (cathode gas) is supplied to the fuel cell stack 1 through the oxidant gas supply flow path (a supply flow path), and oxidant exhaust gas (cathode exhaust gas) is discharged from the fuel cell stack 1 through the oxidant gas discharge flow path (a discharge flow path), but the configurations of the supply flow path and the discharge flow path are not limited to that described above. In the above embodiment, the humidifier 32 is configured by stacking multiple water-permeable membranes 321, but as long as it is provided in the supply flow path and the discharge flow path and humidifies the cathode gas with the moisture contained in the cathode exhaust gas, the configuration of a humidifier can be any form.

In the above embodiment, the pressure of the cathode gas flowing through the dry flow path 32a (a first flow path) inside the humidifier 32, i.e., the dry-side pressure P1 (a first pressure), is calculated by the pressure calculation unit 501, but it may also be detected by a pressure sensor, and the configuration of a first pressure acquisition unit is not limited to that described above. In the above embodiment, the pressure of the cathode exhaust gas (cathode off-gas) in the wet flow path 32b (a second flow path) inside the humidifier 32, i.e., the wet-side pressure P2 (a second pressure), is calculated by the pressure calculation unit 501. That is, the wet-side pressure P2 is calculated based on the pressure loss ΔP2 (a first pressure loss) of the cathode gas from the oxidant gas inlet 31a (a gas inlet portion) to the oxidant gas outlet 31b (a gas outlet portion) of the fuel cell stack 1, and the pressure loss ΔP3 (a second pressure loss) of the cathode exhaust gas from the oxidant gas outlet 31b to the humidifier 32, but the configuration of a second pressure acquisition unit is not limited to that described above.

In the above embodiment, the leakage amount calculation unit 502 calculates the internal leakage amount based on the differential pressure ΔPa (difference) between the dry-side pressure P1 and the wet-side pressure P2, but the configuration of a leakage amount calculation unit is not limited to that described above. In the above embodiment, the output unit 504 controls the gas supply part 55 based on the internal leakage amount L calculated by the leakage amount calculation unit 502, but the configuration of a control unit is not limited to that described above. In the above embodiment, the temperature T1 of the cooling medium flowing into the fuel cell stack 1 is detected by the temperature sensor 53 (a first temperature detection part), and the temperature T2 of the cooling medium flowing out of the fuel cell stack 1 is detected by the temperature sensor 54 (a second temperature detection part), but the configurations of the first temperature detection unit and the second temperature detection unit are not limited to that described above. Without using the temperatures T1 and T2 of the cooling medium, the temperature T11 of the cathode gas at the stack inlet and the temperature T12 of the cathode exhaust gas at the stack outlet may be detected or calculated.

The above describes an example of applying the fuel cell system 100 to a fuel cell vehicle, but the fuel cell system of the present invention can also be applied to other than fuel cell vehicles.

The above embodiment can be combined as desired with one or more of the above modifications. The modifications can also be combined with one another.

According to the present invention, it is possible to detect an internal leakage of a humidifier with an inexpensive configuration.

Above, while the present invention has been described with reference to the preferred embodiments thereof, it will be understood, by those skilled in the art, that various changes and modifications may be made thereto without departing from the scope of the appended claims.

What is claimed is:

1. A fuel cell system comprising:
a fuel cell stack to which a cathode gas including oxygen is supplied through a supply flow path and from which a cathode exhaust gas is discharged through a discharge flow path;
a gas supply part configured to supply the cathode gas to the fuel cell stack through the supply flow path;
a humidifier connected to the supply flow path and the discharge flow path, and configured to humidify the cathode gas with a moisture included in the cathode exhaust gas; and
an electronic control unit including a microprocessor and a memory connected to the microprocessor, wherein the microprocessor is configured to perform:
acquiring information on a first pressure of the cathode gas flowing through a first flow path inside the humidifier;
acquiring information on a second pressure of the cathode exhaust gas flowing through a second flow path inside the humidifier; and
calculating a leakage amount of the cathode gas from the first flow path to the second flow path inside the humidifier, based on a difference between the first pressure and the second pressure.

2. The fuel cell system according to claim 1, wherein
the microprocessor is configured to further perform
controlling the gas supply part based on the leakage amount of the cathode gas.

3. The fuel cell system according to claim 1, wherein
the microprocessor is configured to perform
the acquiring the information on the second pressure including
determining a first pressure loss defined as a pressure loss of the cathode gas from a gas inlet portion of the fuel cell stack to which the supply flow path is connected, to a gas outlet portion of the fuel cell stack to which the discharge flow path is connected, and a second pressure loss defined as a pressure loss of the cathode exhaust gas from the gas outlet portion to the humidifier, and
calculating the second pressure based on the first pressure, the first pressure loss, and the second pressure loss.

4. The fuel cell system according to claim 3, further comprising:
a first temperature detection part detecting a temperature of a cooling medium flowing into the fuel cell stack; and
a second temperature detection part detecting the temperature of the cooling medium flowing out of the fuel cell stack, wherein
the microprocessor is configured to perform
the acquiring the information on the second pressure including
calculating the first pressure loss based on the temperature of the cooling medium detected by the first temperature detection part, and
calculating the second pressure loss based on the temperature of the cooling medium detected by the second temperature detection part.

5. The fuel cell system according to claim 4, wherein
the microprocessor is configured to perform
the acquiring the information on the first pressure including calculating the first pressure, based on a target flow rate of the cathode gas in accordance with a required power generation amount and the temperature of the cooling medium detected by the first temperature detection part.

6. The fuel cell system according to claim 4, wherein
an inlet for the cooling medium and an inlet for the cathode gas provided in the fuel cell stack are disposed adjacent to each other, and
an outlet for the cooling medium and an outlet for the cathode gas provided in the fuel cell stack are also disposed adjacent to each other.

7. The fuel cell system according to claim 2, wherein
the microprocessor is configured to perform
the controlling including controlling the gas supply part so as to increase a flow rate of the cathode gas supplied to the fuel cell stack as the leakage amount of the cathode gas increases, and so as to stop power generation of the fuel cell stack when the leakage amount of the cathode gas exceeds a predetermined amount.

8. The fuel cell system according to claim 1, wherein
the humidifier is configured so that the first flow path and the second flow path are alternately stacked with a water-permeable membrane interposed therebetween.
